(19) United States
(12) Patent Application Publication
(10) Pub. No.: US 2013/0054355 A1
(43) Pub. Date: Feb. 28, 2013

(54) ADVERTISEMENT CUSTOMIZATION

(71) Applicants: Mirza Muhammad Raza, Vancouver (CA); Wook Jin Chung, Sunnyvale, CA (US)

(72) Inventors: Mirza Muhammad Raza, Vancouver (CA); Wook Jin Chung, Sunnyvale, CA (US)

(73) Assignee: Microsoft Corporation, Redmond, WA (US)

(21) Appl. No.: 13/219,900

(22) Filed: Aug. 29, 2011

(51) Int. Cl. G06Q 30/00

(52) U.S. Cl. 705/14.49

(57) ABSTRACT

One or more techniques and/or systems are disclosed for providing a customized advertisement for a user. A request can be received from an advertising service, where the request comprises a user topic, such as a topic comprised in an advertisement intended to be customized for the user. One or more user aspects are identified for the user topic, and respective impact factors are determined for at least some of the one or more user aspects. The user aspects for the user topic can be ranked according to their corresponding impact factors, and the ranking can be returned to the advertising service in response to the request. The advertising service may use at least some of the ranking to customize the advertisement to be shown to the user (e.g., so that higher ranked aspects are emphasized more heavily in the advertisement than lower ranked aspects).

### BACKGROUND

In a computing environment, a user may interact with an abundance of content while online (e.g., while connected to one or more networks, such as the Internet). A user may indicate an interest in an online topic in a variety of ways, such as by searching for the topic using a search website, navigating to an article about the topic, viewing a webpage comprising the topic, “liking” the topic on a social network site, blogging/micro-blogging about the topic, saving online content about the topic, and many more.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Currently, advertisements may be presented to a user when the user interacts with online content. However, such advertisements are not believed to be customized for a particular user based upon a level of interest of the user in a topic or sub-topic (e.g., aspect of a topic). That is, while some advertising services may provide advertisements targeted to a particular audience based on identified preferences and/or cookie information, these advertisements are not believed to be individually customized to a particular user based upon a level of interest of the user in an aspect of a topic.

Accordingly, one or more techniques and/or systems are disclosed for providing an online advertisement customized for a particular user. The advertisement may be customized for the user based upon one or more topics of interest to the user and/or aspects of such topics (e.g., as gleaned from user interaction with online content).

In one embodiment of providing a customized advertisement for a user, a request is received that comprises a user topic, such as a topic comprised in an advertisement intended to be shown to the user. Further, an impact factor can be determined for one or more user aspects that are identified in the user topic. Additionally, a ranking of at least one of the one or more user aspects can be returned to a sender of the request, in response to the request, where the ranking may be based at least upon the impact factor. At least some of the ranking can be used to customize the advertisement that may be shown to the user.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method for providing a customized advertisement for a user.

FIG. 2 is a flow diagram illustrating an example embodiment where one or more portions of one or more techniques described herein may be implemented.

FIG. 3 is a flow diagram illustrating an example embodiment where one or more portions of one or more techniques described herein may be implemented.

FIGS. 4A and 4B illustrate example embodiments of how an advertisement may be customized for the user.

FIG. 5 is a component diagram illustrating an exemplary system for providing a customized advertisement for a user.

FIG. 6 is a component diagram illustrating an example embodiment where one or more systems described herein may be implemented.

FIG. 7 is an illustration of an exemplary computer-readable medium comprising processor-executable instructions configured to embody one or more of the provisions set forth herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

As provided herein, an online advertisement may be customized for a particular user. As an example, interactions of a user with online content and/or entities may yield commonalities that may provide insight into how to customize an advertisement for a user. Weighting factors may be used to indicate a preference for some information over other information, which may allow aspects of topics to be ranked, which in turn may provide an indication of how to customize an advertisement.

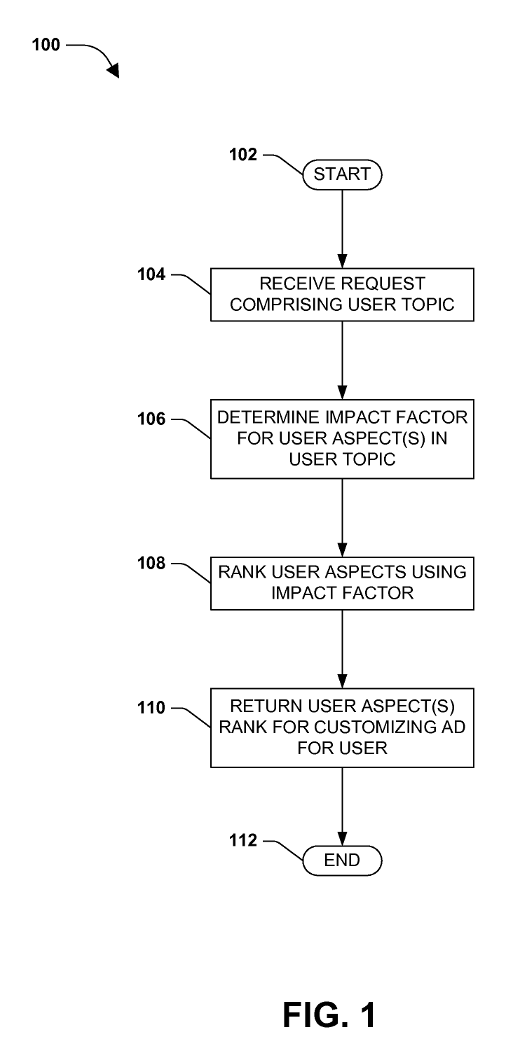

FIG. 1 is a flow diagram illustrating an exemplary method 100 for providing a customized advertisement for a user. The exemplary method 100 begins at 102 and involves receiving a request comprising a user topic, at 104. For example, an online advertising service may provide advertisements that are to be displayed online (e.g., on search sites, social network sites, content aggregation sites, and/or other web-pages). As an example, a client of an online advertising service may create an advertisement comprising one or more topics relevant to the client (e.g., to sell, promote, etc. one or more products and/or services offered by the client). The online advertising service then provides the advertisement to a website, for example, for display thereon. Where a particular user has navigated to the website, for example, the online advertising service can send a request, comprising one or more user topics (e.g., as identified from the one or more topics comprised in the advertisement from the client), in an effort to obtain an advertisement targeted to that particular user.

At 106, respective impact factors are determined for one or more user aspects that are identified in a user topic received in the request (e.g., first impact factor for first user aspect, second impact factor for second user aspect, etc.). As an example, the advertisement associated with the request may be identified as comprising one or more user topics, where respective user topics comprise one or more aspects (e.g., sub-topics). By way of example and not limitation, a user topic may comprise (the categories of) movies, TV shows, theater, music, books, news, apps, places, travel, events, sports, lifestyle, celebrities, food, restaurants, consumer goods, shopping, social graph, and more. Aspects for the user topic “movies” may comprise, for example, genre, language, artists, director, studios, producer, writer, music, etc., where respective aspects can comprise a set of entities. For example, action, drama, comedy, animated, family, etc. may be entities for the “genre” aspect, whereas “Johnny Depp”, “Penelope Cruz”, “Geoffrey Rush”, and “Ian McShane” may be entities for the “actors” aspect.

In one embodiment, one or more user aspects of the user topic, comprised in the request, can be identified and respective impact factors for the one or more user aspects can be determined (e.g., based upon respective sets of entities for the one or more user aspects). An impact factor may, for example, comprise a type of “weighting” factor that indicates a user's level of interest in a particular aspect (e.g., and/or in one or more elements of the set of entities for the aspect). In one embodiment, a level of user interest in an aspect may be determined from previous user online interactions, such as from search query terms, indications of the user “liking” the aspect, navigating to websites related to the aspect, etc.

At 108 in the exemplary method 100, the one or more user aspects of the user topic are ranked, based at least in part upon the respective impact factors determined for the user aspects. Further, the ranking of the user aspects is returned in response to the request, where the ranking is used to customize an advertisement for the user, at 110.

As an illustrative example, a client of the online advertising service may have an advertisement for an upcoming release of the movie “Fantastic Mr. Fox” in retail stores. In this example, the service can send a request comprising the user topic “Fantastic Mr. Fox movie” in response to the user navigating to a website on which the online advertising service expects to display the advertisement for the movie. The user topic may comprise the identified aspects of: actors (George Clooney, Meryl Streep, Bill Murray, etc.), genre (animation, adventure, comedy, family), director (Wes Anderson), writers (Roald Dahl, Wes Anderson), etc. In this example, the user may have previously indicated an interest in Roald Dahl (e.g., by looking for his books online, previewing movie trailers for other Roald Dahl movies, etc.), and animated movies (e.g., by purchasing other animated movies online); and these interests can be used to determine respective impact factors for “writer: Roald Dahl”, “genre: Animation”, and the other aspects of the user topic “Fantastic Mr. Fox movie”. In this example, the respective user aspects of the user topic can be ranked according to their respective impact factors, and the rankings returned to the online advertising service that sent the request.

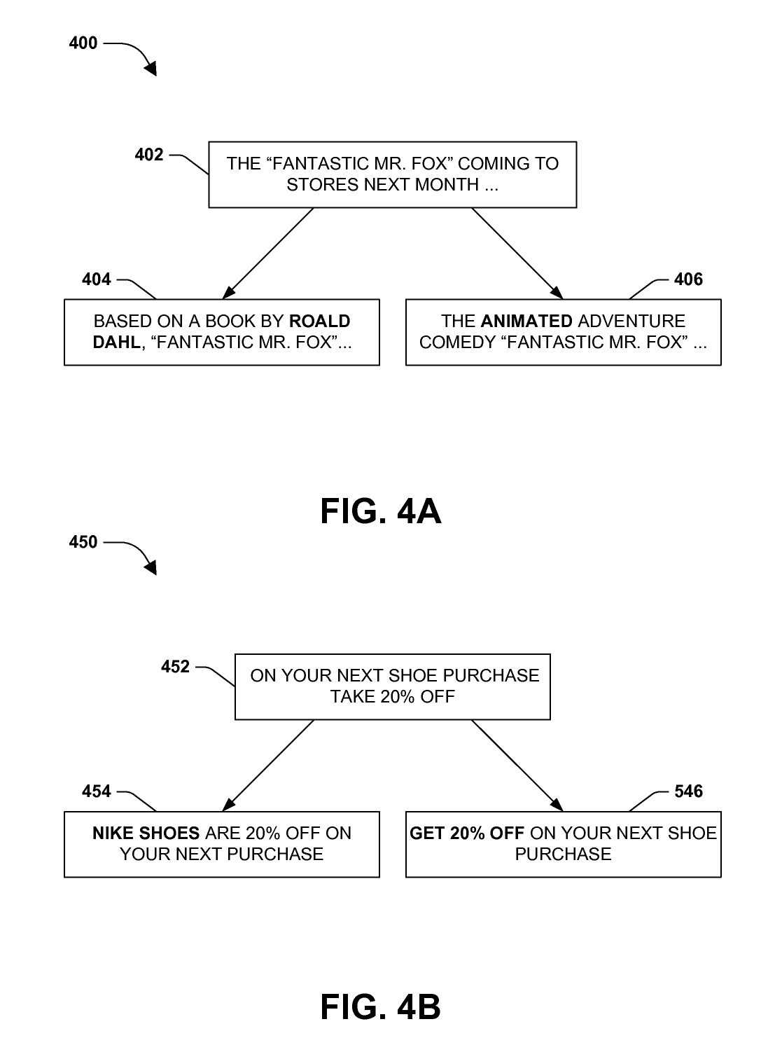

The online advertising service may utilize the ranking of the user aspects, for example, to customize the advertisement on the website for display to the user. As an illustrative example, FIG. 4A illustrates an example embodiment 400 of how an advertisement may be customized for the user. In this example embodiment, a base advertisement 402 comprises proposed language, which may be generalized for a broader audience. Using the rankings of the respective user aspects returned in response to the request, however, the online advertising service (e.g., or the provider of the advertisement) may customize the advertisement for the user, for example, based on the user's previously indicated interests.

In the example embodiment 400, a first customized advertisement 404 may highlight (e.g., bold, change font, color, move to a beginning of the advertisement, etc.) “Roald Dahl” as a writer of the movie (e.g., given that the user previously indicated an interest in Roald Dahl). A second customized advertisement 406 may highlight the fact that the movie is animated (e.g., given that the user previously indicated an interest in animated movies). As another example, a third customized advertisement may highlight a combination of ranked aspects (e.g., highly ranked aspects), such as “The animated “Fantastic Mr. Fox”, based on a book by Roald Dahl, is coming to stores next month.”

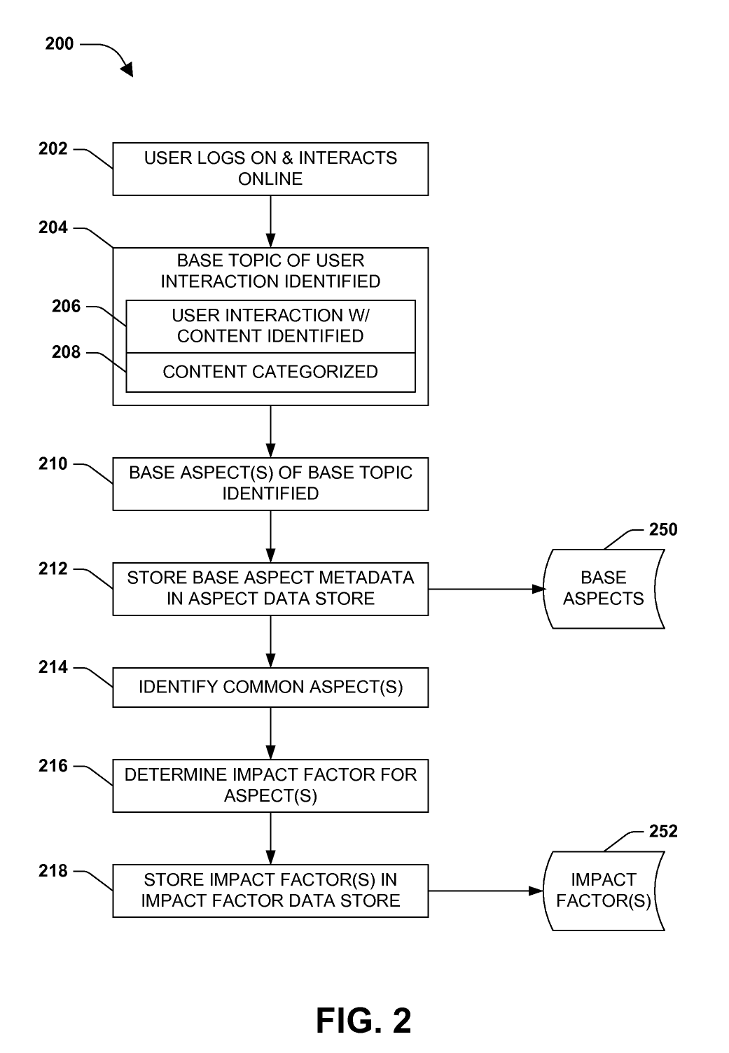

FIG. 2 is a flow diagram illustrating an example embodiment 200 where one or more portions of one or more techniques described herein may be implemented. At 202, a user may log onto their device, connect online (e.g., to the Internet), and interact with online content. At 204, a base topic of the online user interaction can be identified. Identifying the base topic can comprise identifying an indication of the user interacting with the online content, at 206. Further, identifying the base topic can comprise determining a topic category for the online content, resulting in the base topic, at 208. It may be appreciated that “base” and/or the like generally means unadjusted for and/or not targeted to a particular user.

As an example, the user may navigate to an online retailer or shopping service that sells shoes, where the navigation to the site can comprise an online content interaction. As an illustrative example, the user may directly enter a URL for the shoe retailer, select the retailer from search results, select a link on another page, select a link in an email, or some other way to reach the shoe retailer/shopping service site. Information about the navigation and/or resulting landing page may be extracted, for example, to indicate a base topic.

As another example, query terms entered into a search site may comprise an online user interaction from which a base topic can be identified (e.g., the query term(s) can comprise the base topic). Once identified, the base topic may be categorized into one or more topic categories, such as movies, TV shows, theater, music, books, news, apps, places, travel, events, sports, lifestyle, celebrities, food, restaurants, consumer goods, shopping, social graph, and more. In this example, the base topic “shoes”, for example, may be categorized into topic categories “consumer goods” and “shopping”; and/or if the user entered a query term for “Nike shoes” the base topic “Nike shoes”, for example, may be categorized into the topic category of “sports”, as Nike typically sells athletic shoes.

At 210 in the example embodiment 200, one or more base aspects can be identified for the base topic. In one embodiment, identifying the one or more base aspects can based upon metadata associated with the base topic where at least some of this metadata may be regarded as base aspect metadata when used to identify a particular base aspect for the base topic.

As an illustrative example, the user may watch trailers for the animated movies “Toy Story” and “Up” using an online video hosting service. A base topic “movies” can be identified and categorized for the respective online user interactions with the movie trailers. Further, in this example, the respective interactions can be examined to identify metadata, such as base aspect metadata for an “animated - genre” aspect, base aspect metadata for a “Disney - Producers” aspect, base aspect metadata for a “Pixar—Producers” aspect, base aspect metadata for a “Pete Docter - writer” aspect, base aspect metadata for a “winner Academy Award—awards” aspect, and others.

It will be appreciated that an “aspect” of a “topic” is not limited to any particular embodiment, described herein. The aspects of the topic, for example, can comprise and/or be based on any metadata that may be identified for the topic, based on the online user interaction. In one embodiment, base aspect metadata can be identified by crawling one or more online networks (e.g., the Internet) for information about the base topic. For example, for a base topic “Adam Sandler” (e.g., categorized into a “celebrity” topic category), crawling the Internet may identify metadata for base aspects such as “actor,” “comedian,” all the various movies and TV shows he has appeared in, “the Hanukah Song”, his date of birth, place of residence, and more.

At 212, the base aspect metadata for the one or more base aspects 250 can be selectively stored in a corresponding aspect data store. For example, a database may comprise the base topic “Adam Sandler” that is linked to the various base aspect metadata identified by crawling the Internet. In one embodiment, the aspect data store may comprise remote (e.g., cloud-based) storage, for example, connected to a service that may provide advertisement customization services, for example.

At 214, a common aspect can be identified, from the one or more base aspects, from one or more base topics. In one embodiment, a common aspect can comprise a first base aspect from a first base topic that matches a second base aspect from a second base topic. As an example, a first base topic comprising “Toy Story” (e.g., categorized into a “movie” topic category) and a second base topic “Up” (e.g., also categorized into a “movie” topic category) can respectively comprise the common base aspects: genre—animated, producers—Disney, and writer—Pete Docter. That is, in this example, both movies have the genre, producers, and writer in common. As another example, a user's search queries may comprise “Manchester United” (a soccer team), “Lionel Messi” (a soccer player), and “World Cup 2010” (a soccer tournament). In this example, respective base topics: Manchester United (e.g., categorized into a “sports” topic category), Lionel Messi (e.g., categorized into a “sports” topic category), and World Cup 2010 (e.g., categorized into an “events” topic category) may comprise a common base aspect “soccer”.

At 216 in the example embodiment 200, respective impact factors are determined for one or more base aspects, based at least upon the identified common aspect. The impact factors 252 for the one or more base aspects can be stored in an impact factor data store, at 218. As an example, the impact factor can comprise a type of weighting for a base aspect that indicates a level of interest the user may have in the base aspect.

As an illustrative example, a review of base topics for the user (e.g., identified from search queries, articles saved, social network “likes”, etc.) may indicate that the base topics comprise a first common aspect “Nike” for shoe-related topics, athletic-related topics, clothing-related topics. In this example, the first common aspect “Nike” may appear a greater number times in the base topics than a second common aspect “Adidas.” In one embodiment, the common aspect comprising a higher number of appearances (e.g., the first common aspect) may have a higher impact factor that the common aspect comprising a lower number of appearances (e.g., the second common aspect), and such impact factors can be stored in an impact factor data store.

It will be appreciated that determining the impact factor for a base aspect is not limited to the embodiments described herein. The impact factor, for example, can comprise a representation of the users level of interest in a particular aspect of a topic, as determined by the user's online interaction with content that may comprise the topic, and/or the aspect. As an example, those skilled in the art may devise a formula for determining the impact factor that comprises variables that account for the user's level of interest in the aspect.

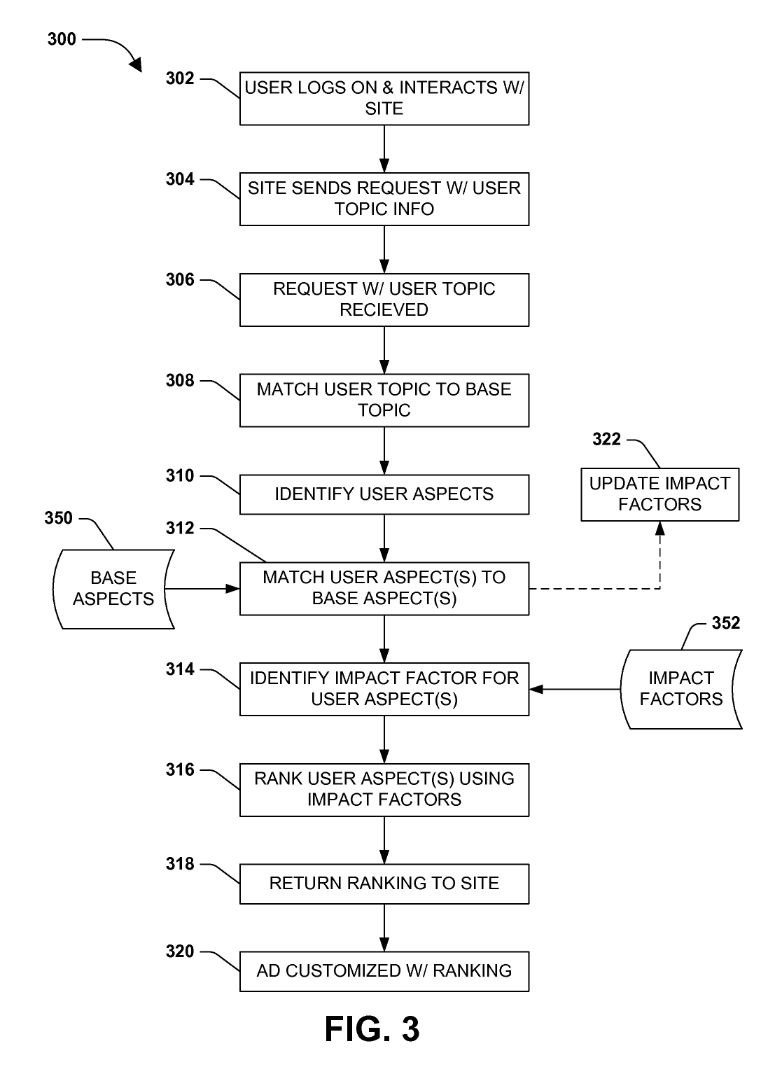

FIG. 3 is a flow diagram illustrating an example embodiment 300 where one or more portions of one or more techniques described herein may be implemented. At 302, a user may log online and interact with a website. At 304, the website (e.g., or an online advertising service associated with the website that provides advertisement services for the website (e.g., advertisements to display on the website)) sends a request comprising a user topic, and the request can be received (e.g., at a local or remote service providing advertisement customization services) along with the user topic, at 306.

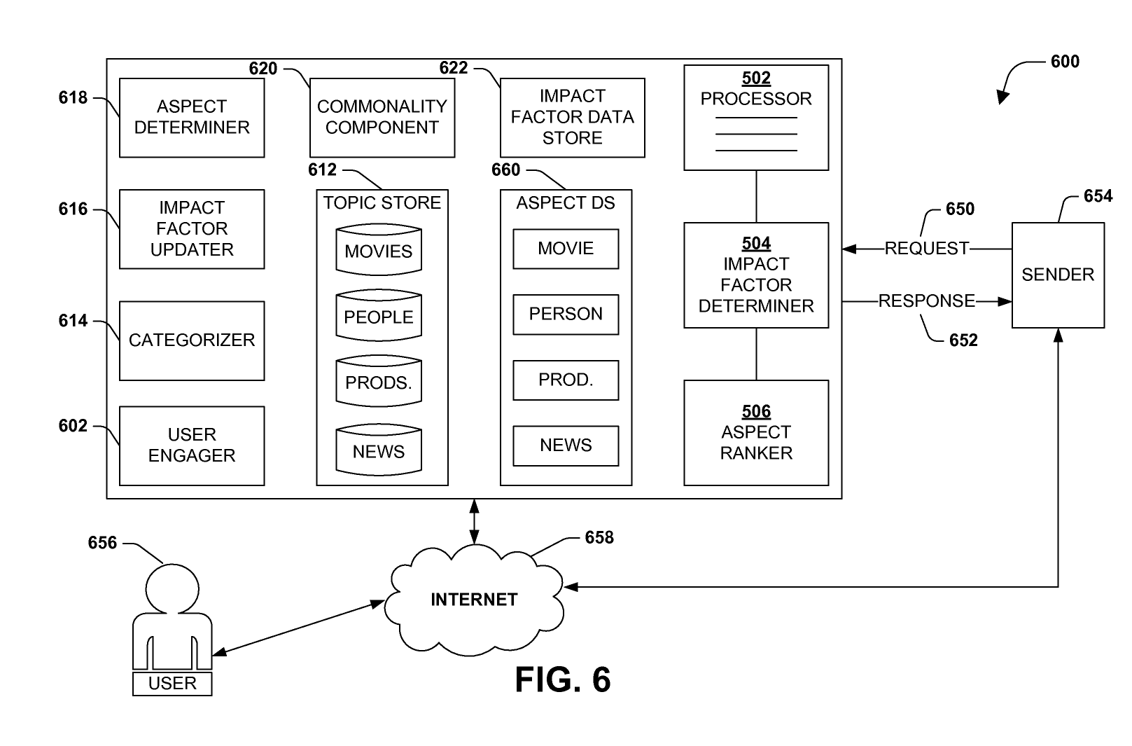

At 308, the user topic can be matched to a base topic stored in a topic data store (e.g., 612 of FIG. 6). As an example, the topic data store can comprise a plurality of base topics that have been categorized into one or more topic categories. The user topic from the request can be matched to one or more of the base topics in one or more topic categories. As an illustrative example, an advertisement intended to be shown to the user on the webpage to which the user navigated may comprise the user topic “shoes” (e.g., for a shoe retailer). In this example, the base topic “shoes” may be found in the topic data store categorized in “consumer goods”, “shopping”, and/or “athletics,” where the user topic and base topic are matched. In one embodiment, if no matching base topic is identified, a “no match” response may be returned to the sender, for example, and the sender may not customize the advertisement for the user.

At 310, one or more user aspects can be identified for the user topic. For example, metadata associated with the user topic may be identified, such as from a topic aspect data base, and/or from information obtained by crawling online networks for the metadata associated with the user topic, and this metadata or portions thereof (e.g., base aspect metadata) may be examined to identify one or more user aspects for the user topic. At 312, the one or more user aspects can be matched to one or more corresponding base aspects 350 associated with the matched base topic, stored in an aspect data store, for example. Further, at 314, an impact factor 352 corresponding to a matched (e.g., first) base aspect can be retrieved from an impact factor data store, for example, for the corresponding (e.g., first) user aspect (e.g., the user aspect that matched the (e.g., first) base aspect).

In one embodiment, instead of identifying the user aspects and matching them to the base aspects, merely the base aspects of the matched base topic may be identified for the user topic. For example, for the user topic “shoes” that is matched to the base topic “shoes”, the base aspects: shoe brands (e.g., Nike, Adidas, Reebok, etc.), shoe types (e.g., running shoes, dress shoes, casual shoes, etc.), which were identified for the base topic “shoes” may be used to retrieve corresponding impact factors for user aspects of the user topic.

As an example, impact factors may have been determined for respective base aspects, from one or more base topics identified from the user's online content interactions. In this example, a stored impact factor may be linked to a corresponding base factor, such as in a database. Further, the base aspect matching the user aspect (e.g., or from the base topic matching the user topic) may be identified in the database, and the linked impact factor can be retrieved and used for the user aspect.

At 316 in the example embodiment 300, the one or more user aspects can be ranked based at least upon the corresponding impact factors. As an illustrative example, the user may enter a query for “sporting goods” on a search website. In this example, a search result (e.g., a sponsored search result) may comprise a website for a national sporting goods provider, for example. Typically, below a search result title, the search website may place some text from a snippet of the associated webpage. In this example, the website may comprise pages for a variety of sports, such as basketball, football, and also soccer. In this example, “soccer” may comprise a higher impact factor than basketball and football, due to the users previous online interactions with soccer related content. Therefore, the “soccer” user aspect may comprise a higher ranking than the other user aspects of the user topic “sporting good,” and may be included in the snippet below the website title in the search results (e.g., sponsored search results).

At 318, the ranking of the one or more user aspects for the user topic can be returned to the online site (e.g., website or online service), and the advertisement can be customized using the ranking. As an illustrative example, FIG. 4B illustrates an example embodiment 450 of how the advertisement may be customized for the user. A base advertisement 452 comprises proposed general language for the advertisement, comprising a user topic of “shoes”. In this example, the user topic “shoes” may be associated with a topic category “consumer goods”, and/or “shopping” (e.g., and possibly “athletics”). Further, the ranking of associated user aspects may identify that for “consumer goods” the highest ranked user aspect comprises “Nike shoes” (e.g., due to the users online interactions with content associated with Nike, and/or Nike shoes); and, for “shopping”, a highest ranked user aspect comprises “savings”, and/or “discounts” (e.g., due to the user's online shopping interactions).

In this example embodiment 450, a first customized advertisement 454 may highlight (e.g., bold, include text, move text, change text color, etc.) the “Nike shoes” angle for the user, which may entice the user to click on the advertisement or interact with the online retailer. Further, a second customized advertisement 546 may highlight the “discount” angle of the advertisement by putting the “20% off”, bolded at the beginning of the advertisement. Additionally, in one embodiment, more than one user aspect may be utilized in the customization of the advertisement. For example, a customization of the base advertisement 452 may comprise “Get 20% of Nike shoes on your next shoe purchase.”

Returning to FIG. 3, at 322, an impact factor for a base aspect corresponding to a user aspect can be updated based at least in part upon an identified user aspect. For example, when the user interacts with online content that may trigger a request from an advertiser (e.g., an advertisement providing service or direct advertiser) to customize an advertisement for the user, the information associated with request may be used to update the user's interests in a particular aspect of a particular topic.

As an illustrative example, the user may navigate to a website that provides reviews of software, hardware, and other electronic devices. In this example, based on the users previous interactions with the website, the advertiser may know that the user may be interested in buying a new camera (e.g., based on site based searches and navigation). The advertiser can request a ranking for user aspects of the user topic “camera” (e.g., brands, types, costs, preferred retailers, specs, etc.), and based on the user aspects matched to the users base aspects, the impact factors may be updated for the base topic camera (e.g., increased due to additional interest indicated for cameras by the user).

A system may be devised that can examine metadata associated with a user's online interactions with content, identify commonalities, and provide a customization scheme to an advertiser to customize advertisements shown to the user based on the commonalities. For example, by identifying the common aspects of the user's online interactions, subsequent user interactions with online content, such as for advertisements, may be customized to cater more to the user. By comparing aspects of user topics from advertisements, for example, with aspects of base topics identified from previous interaction, the advertiser may be able to better “show the user what they want to see”.

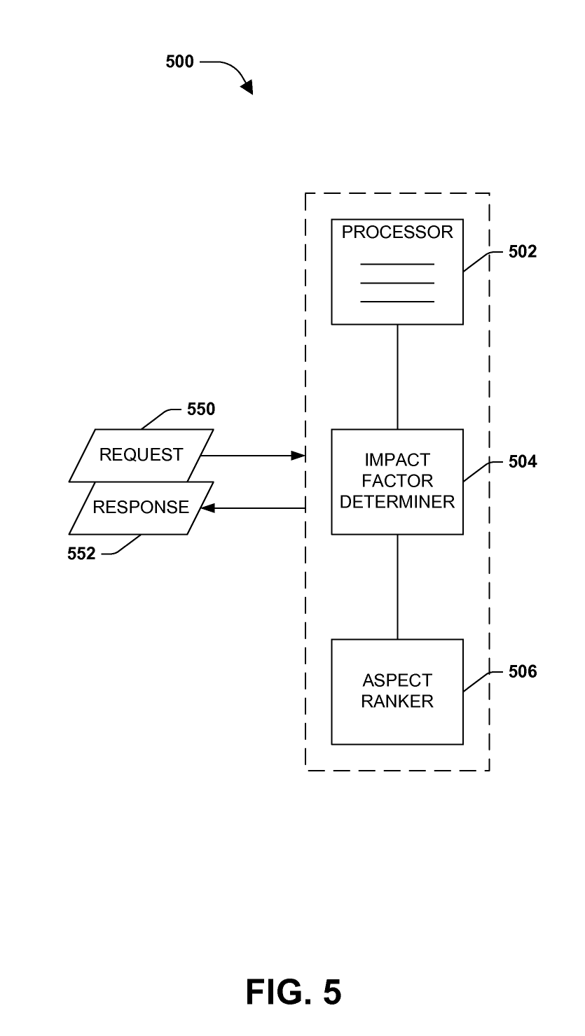

FIG. 5 is a component diagram illustrating an exemplary system 500 for providing a customized advertisement for a user. In the exemplary system 500, a computer-based processor 502, configured to process data for the system, is operably coupled with an impact factor determination component 504. The impact factor determination component 504 is configured to determining respective impact factors for one or more user aspects identified from a user topic received in a first request 550.

Further, in the exemplary system 500, an aspect ranking component 506 is operably coupled with the impact factor determination component 504. The aspect ranking component 506 is configured to return a ranking of at least one of the one or more user aspects in response 552 to the request 550. The ranking is based at least upon the impact factors, and at least some of the ranking is used to customize an advertisement for the user.

FIG. 6 is a component diagram illustrating an example embodiment 600 where one or more systems described herein may be implemented. In this example 600, an extension of FIG. 5 is provided and thus description of elements, components, etc. described with respect to FIG. 5 may not be repeated for simplicity. In the example embodiment 500, a user engagement component 602 can be configured to identify an online user interaction, identify a base topic from the online user interaction, and/or store the base topic in a topic data store 612. For example, when a user 656 interacts with online content (e.g., performing a search, navigating to a site, selecting content to view, saving content, indicating interest in content, etc.), such as on the Internet 658, the user engagement component 602 can identify that interaction as one that may involve a base topic, and identify the base topic (e.g., from the search terms, metadata tags associated with selected content, etc.).

In one embodiment, the user engagement component 602 can be configured to forward the base topic to a categorization component 614. The categorization component may be configured to determine a base topic category for a base topic, and/or store the base topic in a corresponding base topic category data store (e.g., movies, people, products, news). For example, a base topic identified by the user engagement component 602 may be categorized into one or more categories associated with the topic, such as movies, people, products, news, and many more. The base topic can then be stored in a corresponding portion of the topic data store 612, for example, thereby storing one or more user interests based on the user's online content interactions.

In one embodiment, the categorization component 614 can be configured to determine a user topic category for the user topic, such as received in a request 650 for an advertising service (e.g., or advertiser). Further, in one embodiment, the categorization component 614 can be configured to match the user topic category to a base topic stored in the topic data store. As an example, when the request 650, comprising the user topic, is received, the user topic can be categorized, and compared to one or more stored base topics, to identify a match, if present.

In the example embodiment 600, an aspect determination component 618 can be configured to identify one or more base aspects for the base topic, and/or store the identified one or more base aspects in an aspect data store 660. Further, the aspect determination component 618 can be configured to identify one or more user aspects for the user topic. For example, the aspect determination component 618 may connect to one or more online networks (e.g., the Internet 658) to identify metadata associated with a base topic, and store the metadata indicative of a base aspect in a corresponding portion of the aspect data store 650.

For example, a topic comprising a city name may comprise metadata such as location, weather, population, language, government type, attractions, cost-of-living, demographics, entertainment, dining, sports, etc. In this example, the base aspects, and/or the user aspects may comprise the respective metadata associated with the corresponding base topic, and/or user topic. The base aspects of the city base topic can be stored in the aspect data store 660, for example, while the user aspects may be compared to the stored base aspects in order to identify a corresponding impact factor (e.g., stored in relation to a matched base aspect).

A commonality component 620 can be configured to identify a common aspect, from the one or more base aspects, from one or more base topics. For example, the book “Charlie and the Chocolate Factory” as a base topic, comprise a same writer base aspect “Roald Dahl” as the movie “Fantastic Mr. Fox”. Therefore, in this example, the commonality component 620 may identify that the writer “Roald Dahl” comprises a common base aspect between the book base topic “Charlie and the Chocolate Factory” and the movie base topic “Fantastic Mr. Fox”.

Further, the commonality component 620 can also be configured to forward a base aspect corresponding to a common aspect to an impact factor data store 622, and/or match the respective one or more user aspects to a corresponding base aspect, in the aspect data store 660. The impact factor data store 622 can be configured to identify an impact factor for a base aspect corresponding to a common aspect, store the impact factors for the base aspects, and/or provide the impact factor corresponding to a particular (e.g., first) base aspect to the impact factor determination component 504 when one or more user aspects (e.g., a first user aspect) match the particular base aspect.

For example, when the request 650 is received from a sender 654, the respective impact factors for the one or more user aspects obtained from base aspects to which the user aspects matched can be forwarded to the impact factor determination component 504. In this example, the aspect ranking component 506 can rank the one or more user aspects using the corresponding impact factors, and the ranking can be returned in a response 652 to the sender 654, which may use the ranking to customize the advertisement to the user 656.

In the example embodiment 600, an impact factor updating component 616 configured to update the impact factor of a base aspect based at least upon the corresponding user aspect, and or additional instances of the base aspect being identified in a new online user interaction. In this example, the user engagement component 602 can be configured to forward the base topic to the impact factor updating component 616. For example, when the user 656 infracts with online content on the Internet, the one or more new base aspects identified in a new base topic (e.g., comprised in the interaction) can be forwarded to the impact factor updating component 616, which can update the one or more impact factors corresponding to a base aspect stored in the aspect data store 660. Further, the updated impact factors may be provided to the impact factor data store 622 and linked to the corresponding base aspect. In this way, for example, the impact factors may be continually updated based on new and/or ongoing user interactions with online content.

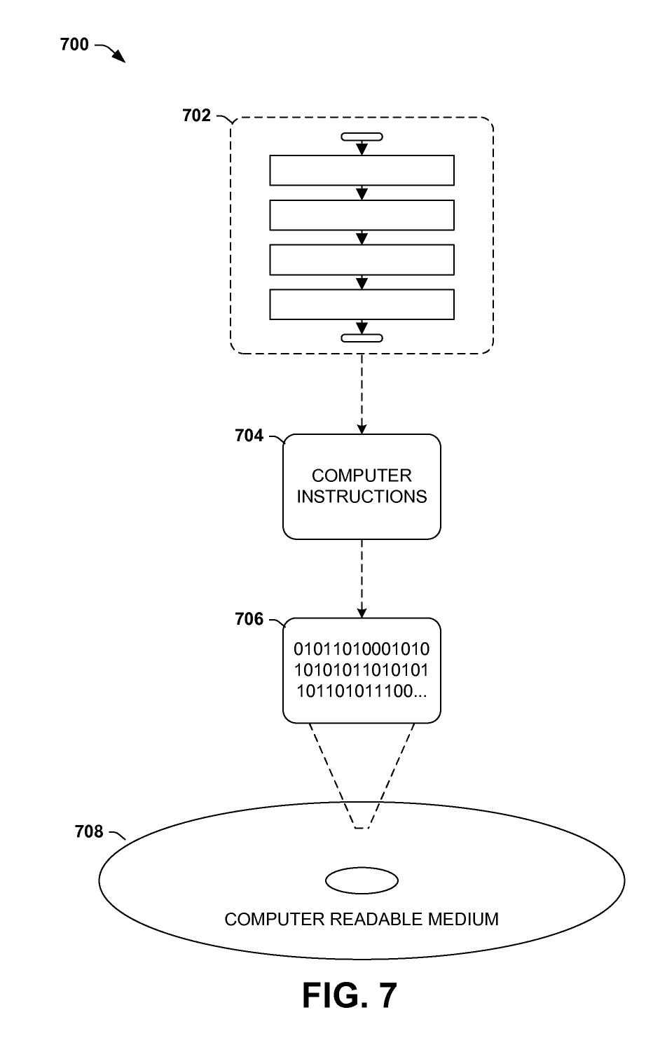

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 708 (e.g., a CD-R, DVD-R, or a platter of a hard disk drive), on which is encoded computer-readable data 706. This computer-readable data 706 in turn comprises a set of computer instructions 704 configured to operate according to one or more of the principles set forth herein. In one such embodiment 702, the processor-executable instructions 704 may be configured to perform a method, such as at least some of the exemplary method 100 of FIG. 1, for example. In another such embodiment, the processor-executable instructions 704 may be configured to implement a system, such as at least some of the exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

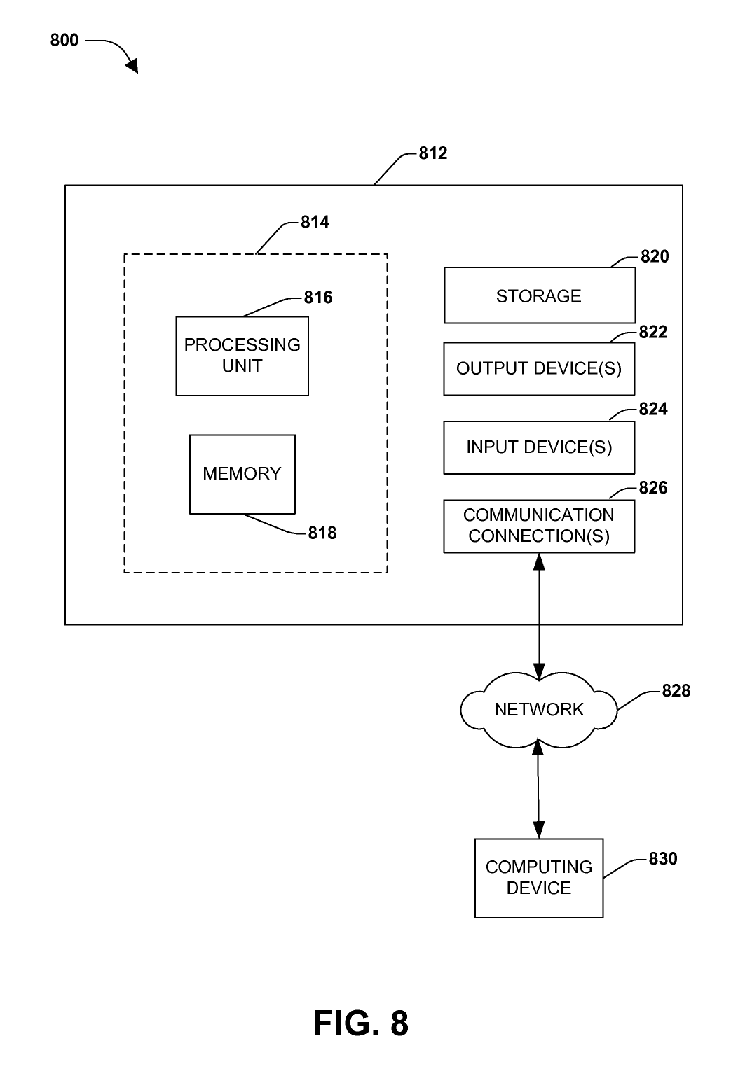

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for providing a customized advertisement for a user, comprising:
receiving a request comprising a user topic;
determining respective impact factors for one or more user aspects identified in the user topic; and
returning a ranking of at least one of the one or more user aspects in response to the request, the ranking based at least upon the impact factors, at least some of at least one of the ranking used to customize an advertisement for the user, and at least some of the receiving, the determining and the returning implemented at least in part via a processing unit.

2. The method of claim 1, comprising identifying a base topic from an online user interaction, comprising one or more of:
identifying an indication of a user interaction with online content; and
determining a topic category for the online content.

3. The method of claim 2, comprising identifying one or more base aspects for the base topic.

4. The method of claim 3, comprising one or more of:
identifying base aspect metadata for the one or more base aspects; and
selectively storing base aspect metadata for the one or more base aspects in corresponding aspect data stores.

5. The method of claim 3, comprising identifying a common aspect among the one or more base aspects for the base topic and one or more second base aspects for a second base topic.

6. The method of claim 5, comprising determining respective impact factors for at least some of the one or more base aspects, based at least upon the identified common aspect.

7. The method of claim 6, comprising storing the respective impact factors for the one or more base aspects in an impact factor data store.

8. The method of claim 2, comprising matching the user topic to a base topic stored in a topic data store.

9. The method of claim 1, comprising identifying the one or more user aspects for the user topic.

10. The method of claim 9, comprising one or more of:
matching a first user aspect of the one or more user aspects to a corresponding base aspect stored in an aspect data store; and
retrieving an impact factor corresponding to the matched base aspect from an impact factor data store.

11. The method of claim 1, comprising ranking at least some of the one or more user aspects based at least upon a corresponding impact factor.

12. The method of claim 1, comprising updating an impact factor for a base aspect based at least in part upon online user interaction.

13. A system for providing a customized advertisement for a user, comprising:
a computer-based processor configured to process data for the system;
an impact factor determination component, operably coupled with the processor, configured to determine respective impact factors for one or more user aspects identified from a user topic received in a first request; and
an aspect ranking component, operably coupled with the impact factor determination component, configured to return a ranking of at least one of the one or more user aspects in response to the request, the ranking based at least upon the impact factors, at least some of the ranking used to customize an advertisement for the user.

14. The system of claim 13, comprising a user engagement component configured to perform one or more of:
identify an online user interaction;
identify a base topic from the online user interaction;
store the base topic in a topic data store;
forward the base topic to a categorization component; and
forward the base topic to an impact factor updating component.

15. The system of claim 14, comprising a categorization component configured to perform one or more of:
determine a base topic category for the base topic, determine a user topic category for the user topic;
store the base topic in a corresponding base topic category data store; and
match the user topic category to a stored base topic.

16. The system of claim 14, comprising an aspect determination component configured to perform one or more of:
identify one or more base aspects for the base topic;
store the one or more base aspect in an aspect data store; and
identify one or more user aspects for the user topic.

17. The system of claim 16, comprising a commonality component configured to perform one or more of:
identify a common aspect among the one or more base aspects for the base topic and one or more second base aspects for a second base topic;
forward a base aspect corresponding to a common aspect to an impact factor data store; and
match a first user aspects to a corresponding base aspect.

18. The system of claim 17, comprising an impact factor data store configured to perform one or more of:
identify an impact factor for a base aspect corresponding to the common aspect;
store the impact factor for the base aspect corresponding to the common aspect; and
provide the impact factor for the base aspect corresponding to the common aspect to the impact factor determination component.

19. The system of claim 13, comprising an impact factor updating component configured to update an impact factor of a base aspect based at least upon online user interaction.

20. A computer readable medium comprising computer executable instructions that when executed via a processing unit on a computer perform a method for providing a customized advertisement for a user, comprising:
identifying a base topic from an online user interaction;
identifying one or more base aspects for the base topic;
identifying a common aspect among the one or more base aspects for the base topics and one or more second base aspects for a second base topic;
determining respective impact factors for at least some of the one or more base aspects, based at least upon the identified common aspect;
receiving a request comprising a user topic;
determining respective impact factors for one or more user aspects identified in the user topic, comprising:
matching a first user aspect of the one or more user aspects to a corresponding base aspect stored in an aspect data store; and
retrieving an impact factor corresponding to the matched base aspect, from an impact factor data store;
ranking at least some of the one or more user aspects based at least upon a corresponding impact factor; and
returning the ranking of at least one of the one or more user aspects in response to the request, at least some of the ranking used to customize an advertisement for the user.
